(19) United States
(12) Patent Application Publication
(10) Pub. No.: US 2011/0170685 A1
(43) Pub. Date: Jul. 14, 2011

(54) COUNTERMEASURE METHOD AND DEVICES FOR ASYMMETRIC ENCRYPTION WITH SIGNATURE SCHEME

(75) Inventors: Bruno Benteo, Vigoulet Auzil (FR); Benoit Feix, La Ciotat (FR); Sébastien Nerot, Jouques (FR)

(73) Assignee: INSIDE CONTACTLESS, Aix-en-Provence (FR)

(21) Appl. No.: 12/840,407

(22) Filed: Jul. 21, 2010

Related U.S. Application Data
(63) Continuation of application No. PCT/FR2009/000072, filed on Jan. 23, 2009.

(30) Foreign Application Priority Data
Jan. 23, 2008 (FR) 08 00345

(51) Int. Cl. H04L 9/28

(52) U.S. Cl. 380/28

(57) ABSTRACT

A countermeasure method in an electronic component implementing an asymmetric private key encryption algorithm includes generating a first output data, using a primitive, and a protection parameter, transforming, using the protection parameter, at least one element of a set consisting of the private key and an intermediate parameter obtained from the first output data, to respectively supply first and second operands, and generating, from an operation involving the first and second operands, a second output data.

### CROSS-REFERENCE TO RELATED APPLICATIONS

This application is a Continuation of International Application No. PCT/FR2009/000072, filed Jan. 23, 2009, which was published in the French language on Sep. 11, 2009, under International Publication No. WO 2009/109715 A2 and the disclosure of which is incorporated herein by reference.

### BACKGROUND OF THE INVENTION

Embodiments of the present invention relate to a countermeasure method in an electronic component implementing an asymmetric private key encryption algorithm, resisting attacks which aim to discover the private key. Embodiments of the present invention also relate to a microcircuit device and a portable device, particularly a chipcard, implementing such a method.

The asymmetric private key encryption is based on the use of primitives P which are usually functions utilizing a one-way, complex resolution problem, such as the Discrete Logarithm Problem and the Elliptic Curves Discrete Logarithm Problem. In other words, for an asymmetric encryption primitive P, involving an input data x, it is simple to calculate y=F(x), but knowing y and the primitive F, it is “hard” to find the value of x. The word “hard” here means “computationally impossible to solve”. In finite fields, F is a modular exponentiation. In the elliptic curves, F is a scalar multiplication on the points of the defined elliptic curve.

Signature schemes constitute a conventional use of the asymmetric encryption. As it is shown in FIG. 1, an algorithmic application of asymmetric encryption with a signature scheme 10 involving the use of a private key d is generally implemented by a microcircuit 12 to authenticate the transmission of a message M by a signature of this message M using the private key d. The private key d is, for example, stored into the microcircuit 12, which includes a memory 14 with a secure memory space 16 provided to that end and a microprocessor 18 to execute the asymmetric encryption algorithm 10.

The microcircuit devices implementing encryption algorithms are sometimes subjected to attacks which aim to determine the secret data, such as the key(s) used and possibly, in some cases, information of the actual messages. Particularly, the asymmetric encryption algorithms with signature scheme are subjected to attacks aiming to discover the private key. Attacks by auxiliary channels constitute a major family of cryptanalysis techniques which utilize some properties of the software or hardware implementations of the encryption algorithms.

Among the known attacks through auxiliary channels, the attacks of Simple Power Analysis (SPA) type or Differential Power Analysis (DPA) type measure the incoming and outgoing currents and voltages in the microcircuit during the execution of the asymmetric encryption algorithm so as to deduce therefrom the private key. The feasibility of this family of attacks has been demonstrated in the article of P. Kocher, J. Jaffe and B. Jun entitled “Differential Power Analysis” published in particular in Advances in Cryptology—Crypto 99 Proceedings, Lecture Notes In Computer Science Vol. 1666, M. Wiener, ed., Springer-Verlag, 1999.

Temporal attacks analyze the time to carry out some operations. Such attacks on asymmetric encryption algorithms are described in the article of P. Kocher, N. Koblitz entitled “Timing attacks on implementations of Diffie-Hellman, RSA, DSS, and other systems” published in particular in Advances in Cryptology—Crypto 96, 16th annual international cryptology conference, Aug. 18-22, 1996 Proceedings.

Attacks by fault injection are also known, such as Differential Fault Analysis (DFA) attacks, which voluntarily causes faults during the execution of the encryption algorithm, for example by disturbing the microcircuit on which it is executing. Such a disturbance may include one (or more) brief lighting(s) of the microcircuit or the generation of one or more voltage peak(s) on one of the contacts thereof. The disturbance thus makes it possible under some conditions to utilize the calculation and behavior errors generated to obtain a part of or even the whole private key.

To fight against these attacks which are various by nature, numerous, very different solutions have been found. Embodiments of the invention more particularly relate to those which relate to a countermeasure method in an electronic component implementing an asymmetric private key d encryption algorithm, which generate a first output data using a primitive, and generate a protection parameter a.

These algorithms generally provide to modify the execution of the primitive using the protection parameter generated.

The protection parameter a is conventionally generated using a pseudo random data generator 20, so that the execution of the primitive by the encryption algorithm 10 is also rendered random, for example by a technique called “masking,” which may also be referred to as a method for transforming or distorting data, since the handling thereof is distorted by a countermeasure section 22 of the microprocessor 18, using the protection parameter a. Thus, the intermediate data of the encryption algorithm and, as a result, the measurable currents are modified by the random protection parameter and the observation thereof does not make it possible to find the true value of the private key. On the other hand, masking does not disturb the actual algorithm, which therefore supplies the same result with or without masking.

For example, during the execution of the asymmetric encryption algorithm known under the name of RSA (after its authors Rivest, Shamir and Adleman), a primitive consisting of a modular exponentiation is executed. An efficient implementation of the primitive uses a binary representation of the private key d by performing iterations on each bit of this binary representation. In each iteration, the calculation made and the de facto energy consumption during the calculation depends on the value of the bit concerned. Consequently, the execution of such a primitive renders the private key particularly vulnerable to the aforementioned attacks. A conventional countermeasure then directly masks the private key using the protection parameter.

A known signature scheme may therefore be protected using this RSA algorithm to sign a message M by application of the modular exponentiation to the message M using the private key d as an exponent. The signature is, in this case, the direct result of the modular exponentiation.

On the other hand, another known signature scheme of applying the Fiat-Shamir heuristic to a zero-knowledge identification protocol may not be protected that way. Such a signature scheme is known: for example the definition thereof may be referred to in the thesis publicly presented and defended by Benoît Chevallier-Mames on Nov. 16, 2006 at the Ecole Normale Supérieure, Paris, called “Public key encryption: constructions and security proofs”, more particularly in chapters 4.1.2 and 4.2.1, pages 27-30. Likewise, Schnorr's identification protocol and El Gamal and

Digital Signature Algorithm (DSA) signatures must be protected in another way. For example, the DSA algorithm, which uses this other signature scheme, includes generating a first output data using a primitive based on the problem of the discrete logarithm and applied using a random variable different from the private key, generating, from an operation involving the first output data and the private key, a second output data, and outputting the first and second output data as a signature.

A countermeasure method for this algorithm is described in D. Naccache et al's article, entitled “Experimenting with faults, lattices and the DSA” published in Proceedings of the 8th International Workshop on Theory and Practice in Public Key Cryptography 2005 (Jan. 23-26, 2005, Les Diablerets, Switzerland), Lecture Notes in Computer Science, vol. 3386/2005, pp 16-28, Springer Ed.

In this document, an attack by fault injection is described. This attack makes it possible, by switching to 0 a certain number of least significant bits of the random variable and by calculating the signature a certain number of times, to deduce the value of the private key.

Protecting the execution of the primitive by masking the random variable is not efficient against the attacks by fault injection in this type of algorithm, since it is not necessary to know the value of the random variable to find the private key. The article therefore provides more complex methods, for example simultaneously combining different techniques.

It is desirable to provide a method of asymmetric encryption resisting attacks of the aforementioned type and which is simple to implement, in particular for algorithms with a signature scheme applying the Fiat-Shamir heuristic to a zero-knowledge identification protocol.

### BRIEF SUMMARY OF THE INVENTION

An embodiment of the invention relates to a countermeasure method in an electronic component implementing an asymmetric private key encryption algorithm, comprising generating a first output data using a primitive, generating a protection parameter, transforming, using the protection parameter, at least one of the elements of the set consisting of the private key and an intermediate parameter obtained from the first output data, to respectively supply first and second operands, and generating, from an operation involving the first and second operands, a second output data.

Thus, the protection parameter is used to protect the execution of the operation which follows the application of the primitive rather than the execution of the actual primitive. This operation is indeed more utilized in the attacks aiming to this type of signature scheme.

According to one embodiment, the countermeasure method includes transforming the private key using the protection parameter, and generating, from a first operation involving the intermediate parameter and the transformed private key, a first intermediate data, generating, from a second operation involving the intermediate parameter and the protection parameter, a second intermediate data, and combining the first and second intermediate data to supply the second output data.

According to one embodiment, the countermeasure method includes transforming the intermediate parameter obtained from the first output data using the protection parameter, and generating, from a first operation involving the transformed intermediate parameter and the private key, a first intermediate data, generating, from a second operation involving the protection parameter and the private key, a second intermediate data, and combining the first and second intermediate data to supply the second output data.

According to one embodiment, the intermediate parameter is the first output data.

According to one embodiment, the primitive is a modular exponentiation for performing an encryption algorithm with a signature scheme of DSA type.

According to one embodiment, the primitive is a scalar multiplication for performing an encryption algorithm with a signature scheme of ECDSA type.

According to one embodiment, the countermeasure method implements an asymmetric encryption algorithm with a signature scheme of the type that applies the Fiat-Shamir heuristic to a zero-knowledge identification protocol.

According to one embodiment, the generation of the protection parameter includes defining a generating function, by successive applications to at least one predetermined secret parameter stored in memory, of a sequence of values only determinable from this secret parameter and this function, and generating the protection parameter in a reproducible way from at least one value of this sequence.

According to one embodiment, the countermeasure method includes defining a plurality of functions, each function generating, by successive applications to at least one corresponding predetermined secret parameter stored in memory, of a corresponding sequence of values only determinable from the corresponding secret parameter and the corresponding function, combining the plurality of sequences of values generated using a predefined relationship to generate a new sequence of values, and generating the protection parameter in a reproducible way from at least one value of this new sequence.

According to one embodiment, the countermeasure method includes defining a generating function, by successive applications to at least one predetermined secret parameter stored in memory, of a sequence of values only determinable from the secret parameter and the function, combining the sequence of values generated with public parameters of the encryption algorithm to generate a new sequence of values, and generating the protection parameter in a reproducible way from at least one value of this new sequence.

According to one embodiment, the countermeasure method includes, after performing the transformation, regenerating the protection parameter to use during the step of generating the second output data.

Another embodiment of the invention is directed to providing a microcircuit device, including a microprocessor to implement a countermeasure method of an asymmetric private key encryption algorithm, at least one secure memory to store the private key, and a data generator for the generation of a protection parameter. The device is configured to generate a first output data using a primitive, transform, using the protection parameter, at least one of the elements of the set consisting of the private key and an intermediate parameter obtained from the first output data, to respectively supply first and second operands, and generate, from an operation involving the first and second operands, a second output data.

According to one embodiment, the microcircuit device is configured to transform the private key using the protection parameter, and generate, from a first operation involving the intermediate parameter and the transformed private key, a first intermediate data, generate, from a second operation involving the intermediate parameter and the protection parameter, a second intermediate data, and combine the first and second intermediate data to supply the second output data.

According to one embodiment, the microcircuit device is configured to transform the intermediate parameter obtained from the first output data using the protection parameter, and generate, from a first operation involving the transformed intermediate parameter and the private key, a first intermediate data, generate, from a second operation involving the protection parameter and the private key, a second intermediate data, and combine the first and second intermediate data to supply the second output data.

According to one embodiment, the intermediate parameter is the first output data.

According to one embodiment, the primitive is a modular exponentiation for performing an encryption algorithm with a signature scheme of DSA type.

According to one embodiment, the primitive is a scalar multiplication for performing an encryption algorithm with a signature scheme of ECDSA type.

According to one embodiment, the microprocessor implements an asymmetric encryption algorithm with a signature scheme of the type applying the Fiat-Shamir heuristic to a zero-knowledge identification protocol.

According to one embodiment, the data generator is configured to generate the protection parameter by defining a generating function, by successive applications to at least one predetermined secret parameter stored in memory, of a sequence of values only determinable from this secret parameter and this function, and generating the protection parameter in a reproducible way from at least one value of this sequence.

According to one embodiment, the data generator is configured to define a plurality of functions, each function generating, by successive applications to at least one corresponding secret parameter predetermined and stored in memory, of a corresponding sequence of values only determinable from the corresponding secret parameter and the corresponding function, combine the plurality of sequences of values generated using a predefined relationship to generate a new sequence of values, and generate the protection parameter in a reproducible way from at least one value of this new sequence.

According to one embodiment, the data generator is configured to define a generating function, by successive applications to at least one predetermined secret parameter stored in memory, of a sequence of values only determinable from the secret parameter and the function, combine the sequence of values generated with public parameters of the encryption algorithm to generate a new sequence of values, and generate the protection parameter in a reproducible way from at least one value of this new sequence.

According to one embodiment, the microcircuit device is configured to, after performing the transformation, regenerate the protection parameter to use during the step of generating the second output data.

Another embodiment of the invention is directed to supplying a portable device, a chipcard in particular, including a microcircuit device such as previously described.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

Embodiments of the present invention will be described in greater details in the following description, in relation with, but not limited to the appended figures wherein in the drawings:

FIG. 1 schematically shows the structure of a microcircuit device of conventional type;

FIG. 2 schematically shows the structure of a microcircuit device according to a first embodiment of the invention;

FIG. 3 schematically shows a chipcard comprising the device of FIG. 2;

FIG. 4 shows the successive steps of a first countermeasure method implemented by the device of FIG. 2;

FIG. 5 shows the successive steps of a second countermeasure method implemented by the device of FIG. 2;

FIG. 6 schematically shows the structure of a microcircuit device according to a second embodiment of the invention; and

FIG. 7 shows the successive steps of a countermeasure method implemented by the device of FIG. 6.

### DETAILED DESCRIPTION OF THE INVENTION

### First Embodiment of the Invention

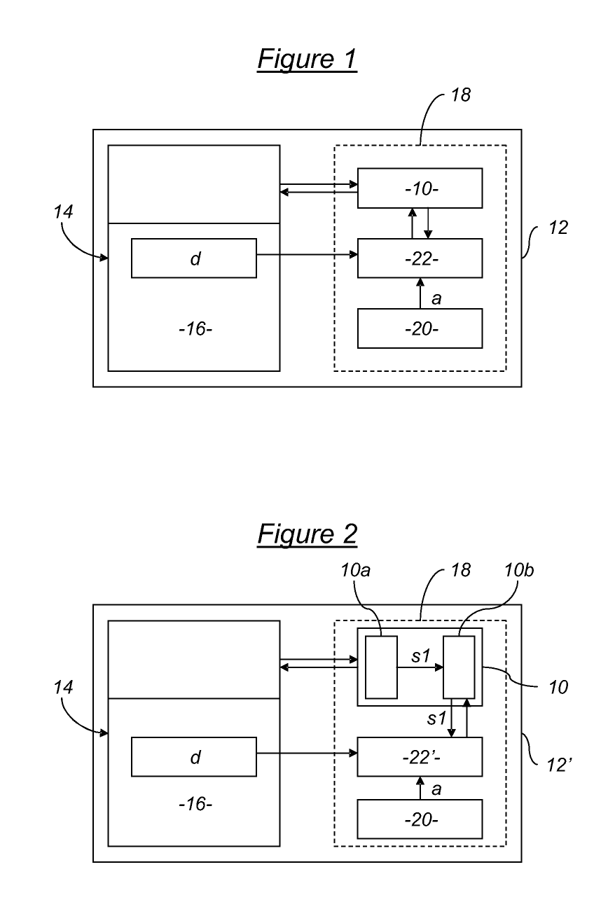

The microcircuit device 12′ shown in FIG. 2 includes, like that shown in FIG. 1, an algorithmic application of asymmetric encryption 10, a memory 14 including a secure memory space 16 for storing, particularly, a private key d intended for being used by the application 10, a microprocessor 18, and a pseudorandom data generator 20 to supply a protection parameter a. The device 12′ also includes a countermeasure section 22′, which brings an improvement to the existing countermeasures, in particular to the countermeasure section 22 previously described.

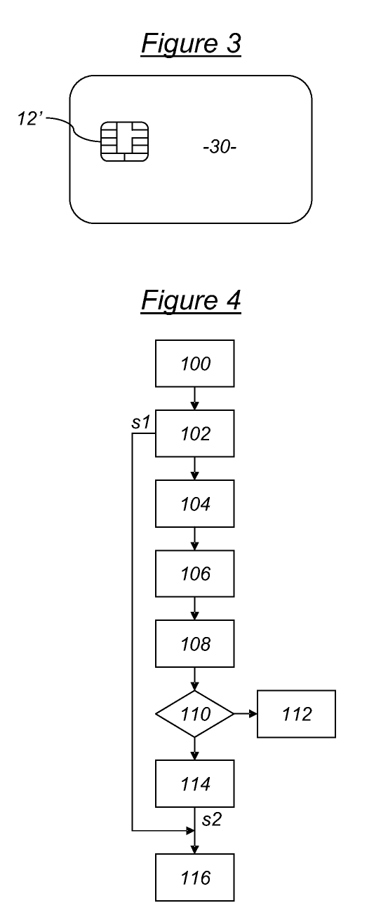

In addition, the device 12′ is, for example, integrated into a portable device, in particular in the form of a secure chipcard 30, as shown in FIG. 3.

It will be noted that, although the algorithmic encryption application 10 and the countermeasure section 22′ are shown as distinct, they may actually be well imbricate into a same implementation, software or hardware, of an asymmetric encryption algorithm including a countermeasure.

In the microcircuit device 12′, the algorithmic application of asymmetric encryption 10 is more precisely adapted for the implementation of a signature scheme of the type applying the Fiat-Shamir heuristic to a zero-knowledge identification protocol. It therefore includes a section 10a for applying a primitive to generate a first output data s1, and a section 10b for executing an operation involving at least two operands, one obtained from the first output data and possibly transformed by the section 22′, the other being the private key, possibly transformed by the section 22′, to generate a second output data s2.

For a signature application using this scheme, the first and second output data constitute the signature (s1, s2).

Contrary to the device 12, in the device 12′ the countermeasure section 22′ is configured to transform, using the protection parameter a, the private key d and/or an intermediate parameter obtained from the first output data. In the case of a DSA signature, the intermediate parameter is the actual first output data.

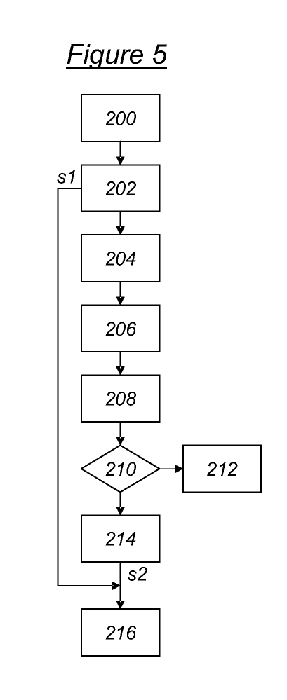

Different countermeasure methods complying with embodiments of the invention may be implemented by the device of FIG. 2. Some of them, non exhaustive, are going to be presented with reference to FIGS. 4 and 5.

A first method of this type, making a signature of DSA type on a message M, is shown by FIG. 4.

During a first step 100 of generation of a couple of keys (a public key and a private key), the following is randomly determined:
a prime number p of L bits, where 512≦L≦1024, and L is divisible by 64,
a prime number q of 160 bits, chosen so that p−1=qz, where z is an integer,
a number h, where 1<h<p−1, chosen so that g=h^{z} mod p>1,
a number d of k bits, so that 0<d<q.

Using these numbers, e=g^{d} mod p is calculated.

The public key is (p, q, g, e). The private key is d.

It is to be noted that a version of the DSA signature allowing sizes of key to be greater is provided by the National Institute of Standards and Technology (NIST), some documents on the subject mentioning a size of 3072 bits for L.

During a second step 102 for applying a primitive, a random variable u is generated, chosen so that 0<u<q. The section 10a then calculates a first output data s1 using the following modular exponentiation:

s1=(g^{u} mod p) mod q.

During a step 104, the pseudorandom data generator 20 generates a protection parameter a which size of binary representation is equal to that of the private key d. Alternately, the generator 20 generates a parameter a′, which size is much lower than that of d, but the binary representation of this parameter a′ is concatenated with itself as many times as necessary, to eventually supply a protection parameter a which size of binary representation is equal to that of d. Alternately too, the generator 20 generates a parameter a′, which is combined to other parameters of the DSA algorithm, like q or s1 previously determined, using a function COMB to supply the protection parameter a:a=COMB(a′, q, s1, . . . ). The parameter generated by the generator 20 (a or a′) is kept in memory for a subsequent use, in particular in an optional way as a verification parameter for the parameter a′ when it is combined to other parameters of the DSA algorithm to form a.

During the following step of masking 106, the countermeasure section 22′ transforms the private key d the following way: d′=d+a.

During a step 108 for calculating an operation involving the first output data s1 and the transformed private key d′, a linear congruence of the following form is performed:
A=u⁻¹(H(M)+d′.s1) mod q, where H(M) is the result of a cryptographic hashing with the known function SHA−1 on the message M.

The following step is an optional verification step 110 which is performed if, during step 104, the parameter a′ generated by the generator 20 has been kept in memory as verification parameter. During this step 110, the parameter a is calculated again, using the function COMB and the public values and/or the values kept in memory used by this function (a′, q, s1, . . . ).

If the value of a has changed between step 104 and 110, it makes it possible to conclude that an attack by fault injection occurred between the two steps. An alert is then transmitted by the encryption application 10 and the encryption algorithm is stopped (112) or a different security reaction is applied.

If the value of a did not change between step 104 and 110, step 114 is performed during which the following calculation is made:

B=(u⁻¹.a.s1) mod q.

It is eventually deduced therefrom a second output data s2, given by the relationship s2=(A−B) mod q.

During a last step 116, the encryption application 10 outputs the value (s1, s2) as DSA signature of the message M.

Alternately, the first method previously described may be modified as follows.

During the masking step 106, the countermeasure section 22′ transforms the first output data s1 the following way: s1′=s1+a.

During step 108, the calculation of the linear congruence operation implies the first transformed output data s 1′ and the private key d:

A=u⁻¹(H(M)+d.s1′) mod q.

During step 114, the following calculation is carried out:

B=(u⁻¹.d.a) mod q.

It is deduced therefrom a second output data s2, by the relationship s2=(A−B) mod q.

Alternately also, the first method previously described may be modified as follows.

During step 108, the calculation of the linear congruence operation implies the first output data s1 and the transformed private key d′:

A=(H(M)+d′.s1) mod q.

During step 114, the following calculation is carried out:

B=(A−a.s1) mod q.

The second output data s2 is deduced therefrom, by the relationship s2=(u⁻¹.B) mod q.

Alternately too, the first method previously described may be modified as follows.

During the masking step 106, the countermeasure section 22′ transforms the first output data s1 the following way: s1′=s1+a.

During step 108, the calculation of the linear congruence operation implies the first transformed output data s1′ and the private key d:

A=(H(M)+d.s1′) mod q.

During step 114, the following calculation is carried out:

B=(A−d.a) mod q.

The second output data s2 is deduced therefrom, by the relationship s2=(u⁻¹.B) mod q.

Alternately too, the first method previously described may be modified as follows.

During step 104, the pseudorandom data generator 20 generates a protection parameter a which size of binary representation is much lower than that of d.

During the masking step 106, the countermeasure section 22′ transforms the private key d the following way: d′=d+a.q.

During step 108, the calculation of the linear congruence operation implies the first transformed output data s1 and the transformed private key d′:

A=(H(M)+d′.s1) mod q.

During step 114, the following calculation is carried out, directly giving the value of the second output data:

S2=(u⁻¹.A) mod q.

The previous countermeasures may also be reproduced by choosing a=−a.

A second method complying with embodiments of the invention, making a signature of Elliptic Curve Digital Signature Algorithm (ECDSA type) on a message M, is shown by FIG. 5.

Let G be an element of an elliptic curve of order q, where q is a prime number greater than 2¹⁶⁰. The curve is also defined by two elements a and b which are elements of a Galois field of cardinality n.

During a first step 200 for generating a couple of keys (a public key and a private key), a number d of k bits, where 0<d<q is randomly determined.

Using this number, Q=d.G mod p is calculated, where the operator “.” refers to the scalar product on the elliptic curve to which G belongs.

The public key is Q. The private key is d.

During a second step 202 for applying a primitive, a random variable u is generated, chosen so that 0<u<q. The section 10a then calculates a first output data s1 using the following scalar product: R=u.G=(x_{R}, y_{R}). The modulo value q of the abscissa x_{R} of R is indeed allocated to s1:s1=x_{R} mod q. If this value is equal to zero, step 202 is performed again and another random variable is generated.

During a step 204, the pseudorandom data generator 20 generates a protection parameter a, which size of binary representation is equal to that of the private key d. Alternately, the generator 20 generates a parameter a′, which size is much lower than that of d, but the binary representation of this parameter a′ is concatenated with itself as many times as necessary, to eventually supply a protection parameter a, which size of binary representation is equal to that of d. Alternately too, the generator 20 generates a parameter a′ which is combined to other parameters of the ECDSA algorithm, such as previously determined q or s1, using a function COMB, to supply the protection parameter a:a=COMB(a′, q, s1, . . . ). The parameter generated by the generator 20 (a or a′) is kept in memory for a subsequent use, in particular in an optional way as a verification parameter for the parameter a′ when it is combined to other parameters of the DSA algorithm to form a.

The following steps 206 to 216 are identical to steps 106 to 116 and will therefore not be detailed.

Likewise, the variations in the first method previously described may also be applied to the second method.

Other methods complying with embodiments of the invention, making signatures other than those aforementioned (DSA and ECDSA) may be achieved. These methods differ from those aforementioned, possibly in the primitive implemented at step 102, 202 to obtain the first output data, and in the operation of steps 108, 114 or 208, 214 allowing the second output data to be obtained.

For example, another method complying with embodiments of the invention may achieve a signature of Schnorr type. In that case, the calculation step of the first output data is identical to step 102. On the other hand, a hash function G is applied to the first output data s1, to obtain an intermediate parameter c=G(M, s1). The intermediate parameter c is supplied by the application 10 to the countermeasure section 22′ instead of s1, for a possible transformation. In addition, the linear congruence applied at steps 108, 114 is slightly modified. Indeed, whereas the linear congruence of the DSA signature is, conventionally and before adaptation according to an embodiment of the invention, s2=u⁻¹(H(M)+d.s1) mod q, the linear congruence of the Schnorr signature is, conventionally and before adaptation according to an embodiment of the invention, s2=(u+d.c) mod q. Therefore d may be replaced by d′ or c by c′ (for example c′=c+a) in this operation to achieve a Schnorr signature using a method complying with embodiments of the invention.

Other methods complying with embodiments of the invention may still be achieved by a similar adaptation of the conventional signatures such as those described in the thesis publicly presented and defended by Benoît Chevallier-Mames on Nov. 16, 2006 at the Ecole Normale Supérieure, Paris, called “Public key encryption:constructions and security proofs”, more particularly in chapter 4.4.

### Second Embodiment of the Invention

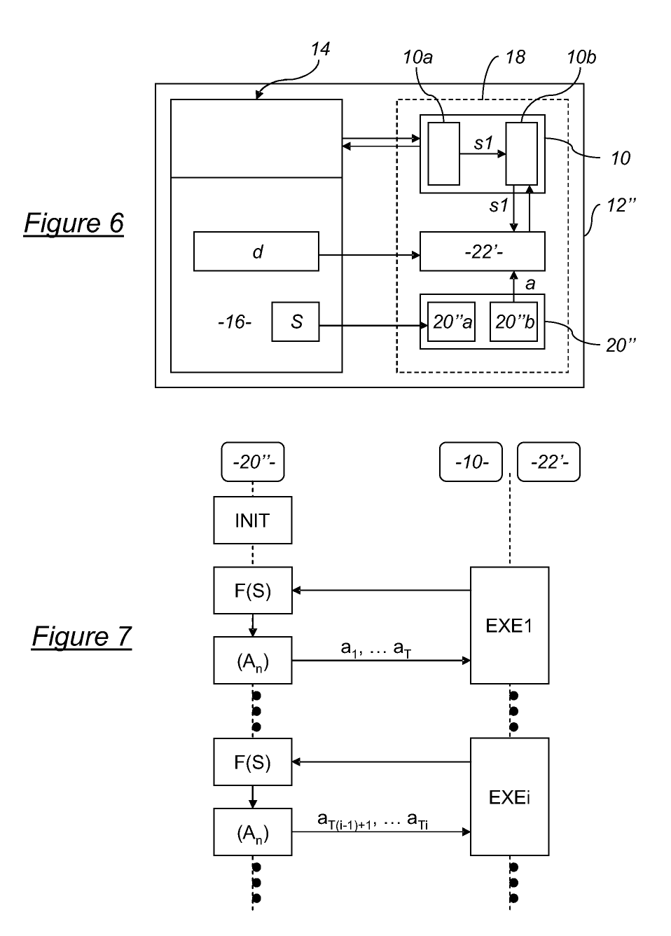

The microcircuit device 12″ shown in FIG. 6 includes, like the device 12′ shown in FIG. 2, an algorithmic application of asymmetric encryption 10, a memory 14 including a secure memory space 16, a microprocessor 18 and a countermeasure section 22′. The device is, for example, integrated into a portable device, in particular in the form of a secure chipcard 30, as shown in FIG. 3. It is however to be noted that, although the algorithmic encryption application 10 and the countermeasure section 22′ are shown as distinct, they may actually be well imbricate into a same implementation of an encryption algorithm including a countermeasure.

Like in the microcircuit device 12′, the algorithmic application of asymmetric encryption 10 of the device 12″ is more precisely adapted for the implementation of a signature scheme of the type applying the Fiat-Shamir heuristic to a zero-knowledge identification protocol. It therefore includes a section 10a for applying a primitive to generate a first output data s1, and a section 10b for executing an operation involving at least two operands, one obtained from the first output data and possibly transformed, the other being the private key possibly transformed, to generate a second output data s2.

In addition, the countermeasure section 22′ of the device 12″ is configured, like that of the device 12′, to transform, using the protection parameter a, the private key d and/or an intermediate parameter obtained from the first output data. In the case of a DSA signature, the intermediate parameter is the actual first output data.

Contrary to the device 12′, in the device 12″ the pseudorandom data generator 20 of conventional type is replaced by a data generator 20″ which includes a section 20″a for applying a predefined function F to at least one predetermined secret parameter S for the generation of a sequence of values only determinable from the secret parameter and the function F, and a section 20″b for supplying at least one protection parameter a in a reproducible way from at least one value of this sequence.

The section 20″a is in fact a software or hardware implementation of the function F.

The secret parameter S is stored in the secure memory 16 and supplied in input of the section 20″a of the generator 20″, while the protection parameter a is supplied, as output of the section 20″b, to the countermeasure section 22′.

In this second embodiment, the parameter a is therefore not a random variable in the conventional meaning mentioned in state-of-art documents. It is a deterministic result resulting from the calculation of the function F executed by the generator 20″ on at least one secret parameter S which may be proprietary to the chipcard 30 on which the microcircuit 12′ is arranged. The secret parameter derives, for example, from public data of the device 30.

The repeated application of the function F to S generates a sequence (An), elements of which are the source of the protection parameter(s) supplied by the generator. Globally, the generator may supply as many parameters a coming from values of the sequence (An) as necessary according to the countermeasure application implemented in the card 30. This sequence (An) may only be reproduced knowing the generator function F and the initial deterministic elements the function uses (parameter S).

Each protection parameter a may directly come from an element An of the sequence (An): in other words, a=An. Alternately, the element An may be subjected to processing before supplying the parameter a. For example, a may be the result of a calculation a=An XOR kn, where kn is a secret transformation constant.

Admittedly, if the sequence (An) is cyclic and/or operates in a finite set of elements, the space of the values An generated must be great enough to resist to attacks. Indeed, the greater the space considered, the more reliable the countermeasure.

First, several non-limiting examples of sequences of values (An) which may be supplied by a generator 20″ according to the second embodiment of the invention will be presented. Then, several possible uses of such sequences of values will be exposed, to supply protection parameters in particular to both countermeasure applications in asymmetric encryption previously described with reference to FIGS. 4 and 5.

Examples of functions generator of sequences of values to supply protection parameters.
1) Functions based on arithmetic-geometric progressions

If the sequence of values (An) is defined using the integer-valued function F by the following relationship:

An+1=F(An)=q.An+r,

where q and r are constituting secret parameters, with the initial element A0 of the sequence, the secret parameters S previously mentioned, it is possible to supply protection parameters coming from an arithmetic-geometric progression. The protection parameters are, for example, the elements of the sequence (An).

If r=0, it is a geometric sequence, a term Ai of which, used at a precise step of the encryption, may be found using the secret parameters q and A0 the following way: Ai=qi.A0.

If q=1, it is an arithmetic sequence, a term Ai of which may be found using the secret parameters r and A0 the following way: Ai=r.i+A0.

If r is not equal to zero and q is different from 1, it is an arithmetic-geometric sequence, a term Ai of which may be found using the secret parameters q, r and A0 the following way: Ai=qi.A0+r.(qi−1)/(q−1).

The space of the elements of the sequence (An) may also be reduced by an integer m using the following relationship:

An+1=F(An) modulo m=(q.An+r) modulo m.

It may be noted that if m is a prime number, this sequence takes the form of the group of reverse affine transformations on the finite field GF(m)={0, 1, . . . , m−1}.

m may also be chosen as a power of 2, to generate sequences of elements with a constant number of bits. For example, if it is wished to generate sequences of k-bit parameters Ai, m=2k is chosen.

Preferably, m is part of the secret parameters to be kept in the secure memory of the device.

### 2) Functions Defining a Cyclic Multiplicative Group

Let GC be a cyclic group with m elements and a value a as generator element and the multiplication as internal principle of composition: GC={a, a2, . . . , am}. The sequence of values (An) may be defined the following way: (i) the initial element A0 is chosen as being the generator element a to which the internal principle of composition of the group GC is applied k times, and (ii) the internal principle of composition of the group GC is applied k′ times to pass from the element Ai to the element Ai+1.

The secret parameters S used by the function generating the sequence (An) are then for example the generator element a and the values k, k′ and m. In addition, like before, the protection parameters generated are for example the elements of the sequence (An).

### 3) Functions Defining a Frobenius Group

Let GF(q) be a finite field, where the order q is a prime number of k bits. The group of reverse affine transformations on this finite field is a Frobenius group. An interesting property of Frobenius groups is that no non-trivial element fixes more than one point.

In this context, the affine transformations usually take the form of functions y=f(x)=b.x+c, where b≠0 and the operations are made in the field GF(q). It is therefore possible to define a function generating the sequence (An) applying to predetermined secret parameters q, b, c and A0. By choosing for example q=216+1 and, in hexadecimal notation, b=0×4cd3, c=0×76bb, A0=0×ef34, a sequence beginning by the terms A1=0×c6cf, A2=0×8baf, A3=0×620d, A4=0×0605, A5=0×xe70c, A6=0×3049, A7=0×xe069, A8=0×55ee, etc. is obtained.

4) Functions Coming from a Shift Register with Linear Feedback (Register of LFSR Type)

These types of functions select a secret parameter A0, for example of 16 bits, and a LFSR shift register, for example, with a corresponding output of 16 bits. If the size of the LFSR register is m, then a term At+m of the sequence (An) is determined by the m previous terms using a linear equation of the type: At+m=αm.At+αm−1.At+1+ . . . +α1.At+m−1, where the αi take the value 0 or 1.

### 5) Functions Defining a Calculation of Cyclic Redundancy Check (CRC)

These types of functions select a secret parameter A0, for example of 16 bits, and a corresponding polynomial CRC among those conventionally used in CRC calculations, for example the polynomial CRC-16 (X16+X15+X2+1) or the polynomial CRC CCITT V41 (X16+X12+X5+1). A term An+1 of the sequence (An) is determined according to the previous term An by the relationship An+1=F(An), where F makes a CRC calculation based on the chosen polynomial.

### 6) Combinations of Sequences of Values

It is indeed also possible to calculate several sequences of values, each for example according to one of the methods detailed hereinbefore, and to combine the sequences using a predefined function to generate a new sequence of values to be used as a protection parameter. The sequence (An) is thus generated, according to two other sequences (A′n) and (A″n), by calculating for each index n, An=T(A′n, A″n).

The function T may be a secret matrix of values, the values A′n and A″n then respectively referring to a row and a column of the matrix.

### 7) Combinations Involving a Sequence of Values and Public Data

The sequence (An) may be generated from a first sequence (A′n), also according to public data, for example like data used during the execution of the encryption application, with countermeasure and not secret. Among these data, according to the applications, the message M (clear or coded), a public key e, or the like may be cited. The values of the sequence used as protection parameters are then calculated using any function COMB combining all these data:

An=COMB(A′n, M, e, . . . ).

An advantage of this combination is that the sequence of values (An) may be used, not only to feed protection parameters to the countermeasure application of the encryption algorithm, but also to detect attacks by fault injection (in particular on public data). Indeed, by regeneration of the sequence (A′n) using the secret parameter(s) at the end of the execution of the encryption algorithm, for example, but before performing the inverse operation of the initial transformation using a regenerated protection parameter, then by using this regenerated sequence (A′n) and public data as they appear at the end of execution, it is possible to check if the application of the function COMB produces the same sequence of values (An) or not, and therefore if public data have been affected or not during execution.

Examples of use of a sequence of values generated according to one of the aforementioned methods in an asymmetric encryption countermeasure method, according to the second embodiment of the invention

### 1) General Principle of the Second Embodiment

Generally, each time an algorithmic countermeasure is used, the generation of random variables introduced by the countermeasure is recommended, as it has been described in the first embodiment using a pseudorandom data generator 20. As mentioned with reference to FIG. 6, the generation of random variables may be replaced by the non random generation of parameters coming from one or more sequence(s) of values obtained using at least one secret parameter.

FIG. 7 shows an example of steps performed by a method according to the second embodiment of FIG. 6, applied to the execution of an asymmetric encryption algorithm with countermeasure, using T protection parameters a1, . . . aT by execution, all the protection parameters may be extracted from a same sequence of values (An) generated by the section 20′a.

During a first step INIT performed by the generator 20″, a counter i is reset. The counter i is intended for keeping in memory the number of times that the asymmetric encryption algorithm has been executed since the reset step INIT, as long as another reset is not performed.

During this step, the secret parameter S (or the parameters S when they are more than one), from which the sequence of values must be generated, is defined. It may be kept from a previous reset, but may also be generated based on a new value on the occasion of the reset. It is for example generated from unique identification data, such as a public data of the device 30. It may also be generated from parameters or physical phenomena linked to the microcircuit at a given time, which may be random. In any case, it is kept in memory in a secured way, to allow the microcircuit to regenerate at anytime a same sequence of values (An) using the function implemented by the section 20″a.

The reset step INIT may be unique in the microcircuit life cycle, performed during the design by the manufacturer, or reproduced several times, for example regularly or each time the counter i reaches a value imax.

During a first execution EXE1 of the asymmetric encryption algorithm with countermeasure, the generator 20″, more particularly the section 20″a, is called upon one or more times to apply the secret parameter S to the predefined function F, so as to generate, one or more times, a number T of elements of the sequence of values (An): A1, . . . AT. From these T first elements, the T protection parameters a1, . . . aT are generated.

For example, for any k such as 1≦k≦T, ak=Ak.

Alternately, if there are T additional secret values Sec1, . . . SecT among the secret parameters S kept in secure memory, it is possible to perform the following additional calculation:
for any k such as 1≦k≦T, ak=Seck XOR Ak, or ak=Seck ADD Ak, or ak=Seck SUB Ak, so as to transform (or distort or mask) the parameters used.

Thereafter, during a ith execution EXEi of the encryption algorithm with countermeasure, the generator 20″, more particularly the section 20″a, is called upon again one or more times to apply the secret parameter S to the predefined function F, so as to generated, in one or more times, a number T of additional elements of the sequence of values (An): AT(i−1)+1, . . . ATi. From these T additional elements, the T protection parameters a1, . . . aT are generated, like previously.

For example, for any k such as 1≦k≦T, ak=AT(i−1)+k.

Alternately, if there are T additional secret values Sec1, . . . SecT, it is possible to perform the following additional calculation:
for any k such as 1≦k≦T, ak=Seck XOR AT(i−1)+k, or ak=Seck ADD AT(i−1)+k, or ak=Seck SUB AT(i−1)+k, so as to transform (or distort or mask) the parameters used.

Whatever is the method used to generate the sequence(s) of values at the origin of the protection parameters, knowing the method and secret values used by the method, including the initial parameter A0 previously loaded into memory or during a step of the life cycle of the microcircuit device in memory EEPROM, makes it possible to find the protection parameters generated and used during the life of the device. It appears that this particularity then allows simple and efficient debugging to be performed and resistance to attacks by fault injection to be improved.

The choice of the method used to generate the sequence of values and the protection parameter(s) is dictated by the contemplated application.

2) Application of the General Principle of the Second Embodiment to the Two Methods Described with Reference to FIGS. 4 and 5.

The method shown in FIGS. 4 and 5 to generate the protection parameter a or the parameter a′ during steps 104 and 204 may be one of those recommended in the second embodiment. This parameter a′ and the protection parameter a may therefore not need to be kept in memory since the parameters a′ and a may be found anytime from the sequence of values which is determined by the secret parameter(s) and the function F. This process of regenerating these parameters is even a useful step for the protection of the implementation against attacks by fault injection. Thus, the parameter a′ may be found at steps 110 and 210 without needing to be previously kept in memory during the execution of steps 104 and 204. At these steps 110 and 210, the protection parameter a may also be found to check that the integrity thereof, and the integrity of the parameters used to generate it, has been kept. It is also useful to regenerate a to perform steps 112 and 212, which use this parameter.

The countermeasure methods previously described make it possible to achieve asymmetric encryption applications protecting the private key used against attacks by auxiliary channels or fault injection.

It is in addition to be noted that the invention is not limited to the aforementioned embodiments and that, although numerous variations have been presented, others may also be contemplated in particular providing other types of transformations of the private key than those which have been described, or other asymmetric encryption applications than those treated above.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A countermeasure method in an electronic component implementing an asymmetric private key encryption algorithm, the method comprising:
generating a first output data using a primitive,
generating a protection parameter,
transforming, using the protection parameter, at least one element of a set of elements consisting of the private key and an intermediate parameter obtained from the first output data, to respectively supply first and second operands, and
generating, from an operation involving the first and second operands, a second output data.

2. The countermeasure method according to claim 1, further comprising:
transforming the private key using the protection parameter, and
generating, from a first operation involving the intermediate parameter and the transformed private key, a first intermediate data,
generating, from a second operation involving the intermediate parameter and the protection parameter, a second intermediate data, and
combining the first and second intermediate data to supply the second output data.

3. The countermeasure method according to claim 1, further comprising:
transforming the intermediate parameter obtained from the first output data using the protection parameter, and
generating, from a first operation involving the transformed intermediate parameter and the private key, a first intermediate data,
generating, from a second operation involving the protection parameter and the private key, a second intermediate data, and
combining the first and second intermediate data to supply the second output data.

4. The countermeasure method according to claim 1, wherein the intermediate parameter is the first output data.

5. The countermeasure method according to claim 4, wherein the primitive is a modular exponentiation for making an encryption algorithm with a signature scheme of DSA type.

6. The countermeasure method according to claim 4, wherein the primitive is a scalar multiplication for making an encryption algorithm with a signature scheme of ECDSA type.

7. The countermeasure method according to claim 1, implementing an asymmetric encryption algorithm with a signature scheme of the type applying the Fiat-Shamir heuristic to a zero-knowledge identification protocol.

8. The countermeasure method according to claim 1, wherein the generation of the protection parameter comprises:
defining a generating function, by successive applications to at least one predetermined secret parameter stored in memory, of a sequence of values only determinable from the secret parameter and the function,
generating the protection parameter in a reproducible way from at least one value of the sequence.

9. The countermeasure method according to claim 8, further comprising:
defining a plurality of functions, each function generating, by successive applications to at least one corresponding predetermined secret parameter stored in memory, a corresponding sequence of values only determinable from the corresponding secret parameter and the corresponding function,
combining the plurality of generated sequences of values using a predefined relationship to generate a new sequence of values, and
generating the protection parameter in a reproducible way from at least one value of the new sequence.

10. The countermeasure method according to claim 8, further comprising:
defining a generating function, by successive applications to at least one predetermined secret parameter stored in memory, of a sequence of values only determinable from the secret parameter and the function,
combining the generated sequence of values with public parameters of the encryption algorithm to generate a new sequence of values,
generating the protection parameter in a reproducible way from at least one value of the new sequence.

11. The countermeasure method according to claim 8, further comprising:
after performing the transformation, regenerating the protection parameter to use during the step of generating the second output data.

12. A microcircuit device comprising a microprocessor configured to implement a method for countermeasuring an asymmetric private key encryption algorithm, at least one secure memory to store the private key, and a data generator configured to generate a protection parameter, the device being configured to:
generate a first output data using a primitive,
transform, using the protection parameter, at least one element of a set consisting of the private key and an intermediate parameter obtained from the first output data, to respectively supply first and second operands, and
generate, from an operation involving the first and second operands, a second output data.

13. The microcircuit device according to claim 12, further configured to:
transform the private key using the protection parameter, and
generate, from a first operation involving the intermediate parameter and the transformed private key, a first intermediate data,
generate, from a second operation involving the intermediate parameter and the protection parameter, a second intermediate data, and
combine the first and second intermediate data to supply the second output data.

14. The microcircuit device according to claim 12, further configured to:
transform the intermediate parameter obtained from the first output data using the protection parameter, and
generate, from a first operation involving the transformed intermediate parameter and the private key, a first intermediate data,
generate, from a second operation involving the protection parameter and the private key, a second intermediate data, and
combine the first and second intermediate data to supply the second output data.

15. The microcircuit device according to claim 12, wherein the intermediate parameter is the first output data.

16. The microcircuit device according to claim 15, wherein the primitive is a modular exponentiation for performing an encryption algorithm with a signature scheme of DSA type.

17. The microcircuit device according to claim 15, wherein the primitive is a scalar multiplication for performing an encryption algorithm with a signature scheme of ECDSA type.

18. The microcircuit device according to claim 12, wherein the microprocessor is configured to implement an asymmetric encryption algorithm with a signature scheme of the type applying the Fiat-Shamir heuristic to a zero-knowledge identification protocol.

19. The microcircuit device according to claim 12, wherein the data generator is configured to generate the protection parameter by:
defining a generating function, by successive applications to at least one predetermined secret parameter stored in memory, of a sequence of values only determinable from the secret parameter and the function, and
generating the protection parameter in a reproducible way from at least one value of the sequence.

20. The microcircuit device according to claim 19, wherein the data generator is configured to:
define a plurality of functions, each function generating, by successive applications to at least one corresponding predetermined secret parameter stored in memory, a corresponding sequence of values only determinable from the corresponding secret parameter and the corresponding function,
combine the plurality of sequences of values generated using a predefined relationship to generate a new sequence of values,
generate the protection parameter in a reproducible way from at least one value of the new sequence.

21. The microcircuit device according to claim 19, wherein the data generator is configured to:
define a generating function, by successive applications to at least one predetermined secret parameter stored in memory, of a sequence of values only determinable from the secret parameter and the function,
combine the sequence of values generated with public parameters of the encryption algorithm to generate a new sequence of values,
generate the protection parameter in a reproducible way from at least one value of the new sequence.

22. The microcircuit device according to claim 19, further configured to, after performing the transformation, regenerate the protection parameter to use during the step of generating the second output data.

23. A portable device comprising the microcircuit device according to claim 12.
